(19) United States
(12) Patent Application Publication
(10) Pub. No.: US 2021/0097608 A1
(43) Pub. Date: Apr. 1, 2021

(54) Recommendation System for Providing Options on a User Interface

(71) Applicant: TD Ameritrade IP Company, Inc., Omaha, NE (US)

(72) Inventors: Sean Ming-Yin LAW, Ann Arbor, MI (US); Abd Alrazzak HABRA, West Bloomfield, MI (US); Ashish RATHOD, Novi, MI (US)

(21) Appl. No.: 16/587,544

(22) Filed: Sep. 30, 2019

(51) Int. Cl. G06Q 40/04

(52) U.S. Cl. CPC G06Q 40/04

(57) ABSTRACT

A recommendation system includes an input module, an input process in module, a selection module, a recommendation module, a trade module, a trade selection module, and a user return module. The system receives user input form a user interface and determines a requested option and security. A recommendation module compares the requested security to a recommendation database of all user and all securities of the enterprise purchased by all the users of the enterprise using a pair of smaller databases derived from the database. The recommended securities are returned to a trade module that receives the recommended securities and a list of option trades available based on the recommended securities and the option trades. The user interface presents the option trades to the user for selection and execution.

### FIELD

The present disclosure relates to systems and methods for a user interface and, more particularly, to a user interface providing content recommendations responsive to input from the user interface.

### BACKGROUND

In the financial services industry, clients or users may be presented with an extensive number of product choices, such as stocks, bonds, mutual funds, and options. Some product choices are more complicated than others, and the complexity of the choices can cause clients or users to avoid selected product choices, resulting in underutilization of various opportunities to the clients or users. For example, with respect to options, option trading choices include not only selecting an underlying security, but also a strategy, such as a call, put, long, short, and shape.

Clients or users are typically busy and have limited time. Selection of securities to trade, however, can be a time-consuming undertaking. Further, clients or users find themselves wanting to initiate security transactions while on the go or while multitasking. Present systems do not facilitate efficiently selecting the purchase or sale of securities, particularly with respect to trading options in those securities.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A recommendation system includes an input module that receives a request from a user that is a client of an enterprise. The input processing module receives the request and determines a requested option and requested security in accordance with the request. A selection module receives the requested option and requested security and determines matching securities in accordance with the requested option. A recommendation module communicates with the selection module, wherein a recommendation module receives the requested security and generates the matching securities in accordance with the requested security, and the recommendation module compares the requested security to a matrix of all users of the enterprise and all securities purchased by all users of the enterprise. The comparison of the requested security with the matrix includes factorizing the matrix in accordance with predetermined latent factors, and the recommendation module returns the matching securities to the selection module. A trade module receives the matching securities and receives trade criteria for the user. The trade selection module receives the matching securities and the trade criteria and generates at least one option trade in accordance with the matching securities and the trade criteria. The trade selection module returns the at least one option trade to the trade module. A user return module receives the at least one option trade from the trade module, and the user return module generates a selection list to the user for available option trade based on the at least option trade. The user selects at least one option trade from the selection list, thereby requesting execution of the selected at least one of the at least one option trade.

A recommendation method includes receiving a request from a user that is a client of an enterprise and determining a requested option and requested security in accordance with the request. The recommendation method determines a matching securities in accordance with the requested option, generates the matching securities in accordance with the requested security, and compares the requested security to a matrix of all users of the enterprise and all securities purchased by all users of the enterprise. The comparison includes factorizing the matrix in accordance with a predetermined latent factors and returning the matching securities to the selection module. The recommendation method further generates at least one option trade in accordance with the matching securities and the trade criteria, and returns the at least one option trade to the trade module. The recommendation method generates a selection list to the user for available option trade based on the at least one option trade. The user selects at least one option trade from the selection list thereby requesting execution of the selected at least one of the at least one option trade.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a block diagram of an example recommendation system according to the principals of the present disclosure;

FIG. 2 is an example matrix of users versus interest in selected securities;

FIG. 3 is an example matrix of FIG. 2 with relative rankings inserted into the undetermined cells of the example matrix of FIG. 2;

FIG. 4 is an example factorization of the matrix of FIG. 3;

FIG. 5 is an example of rankings of selected securities based upon prior purchases by a given user; and

FIG. 6 is a flow chart of an example operation performed by an implementation of the recommendation system.

In the drawings, reference numbers may be reused to identify similar and/or identical elements.

### DETAILED DESCRIPTION

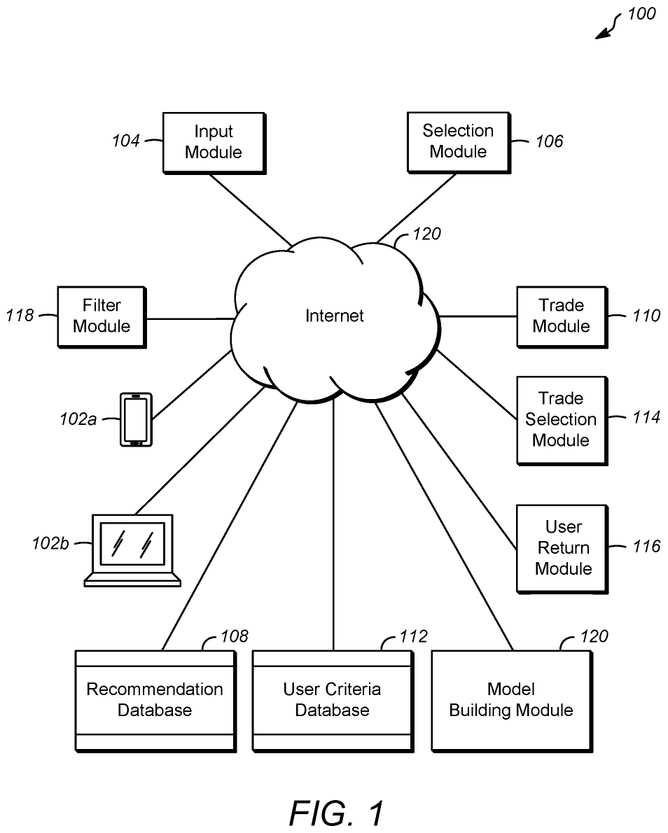

FIG. 1 depicts an example recommendation system 100. Recommendation system 100 includes input devices 102a, 102b, collectively referred to as input device 102, which may be portable devices such as a smart phone or tablet 102a or a computer or laptop 102b. Input module 104 receives input from input device 102. In various embodiments, the input can be speech, text, gestures, or neural inputs. Input module 104 may include voice recognition and text processing submodules. Input module 104 parses the request from input device 102 and generates an initial selection criteria, such as security to be traded, the manner of trading the security, and the vehicle through which the security is traded. Selection module 106 generates a predetermined list of preferred matching securities based upon the selection criteria received from input device 102 and processed by input module 104.

In various embodiments, selection module 106 communicates with a recommendation database 108, which will be described in greater detail herein. Recommendation database 108 returns recommendations based upon the received input criteria. Recommendation database 108 communicates with selection module 106 to return a set or list of securities of potential interest based upon the received user criteria. Recommendation database 108 communicates with a model building module 120. Model building module 120 provides updated or new models to recommendation database 108. Model building module 120 may provide models on a periodic basis, including daily, hourly, or some other period. Selection module 106 receives the returned list or set to generate a set or subset of securities of likely preferred interest to the user. Based upon the set of securities of preferred interest, a trade module 110 generates a set of trades based upon the set of securities output by selection module 106. Trade module 110 communicates with a user criteria database 112 and trade selection module 114.

User criteria database 112 stores for each user predetermined criteria for trade section. The criteria can include, by way of non-limiting example, risk tolerance, success probability, expiration date ranges, and the like. Trade selection module 114 receives the set of likely preferred securities output by trade module 110 and the criteria from user criteria database 112 and generates a list of options to be traded which substantially match the user criteria for one or more of the set of likely preferred securities. A user return module 116 receives the potential option trades matching the user criteria output by trade module 110 and returns the potential option trades to user device 102. User return module 110 may return a combination of text, speech, or graphics for output on user devices 102 to allow the user to select from the matching trades output by trade module 110.

Filter module 118 represents one or more filters that can narrow sets or lists of choices in the implementation of recommendation system 100. A network 120 may interconnect the elements of recommendation system 100. In various embodiments, the elements of recommendation system 100 communicate via network 120, connect directly, or connect through an intermediate element, including via a cloud, Internet, or intranet.

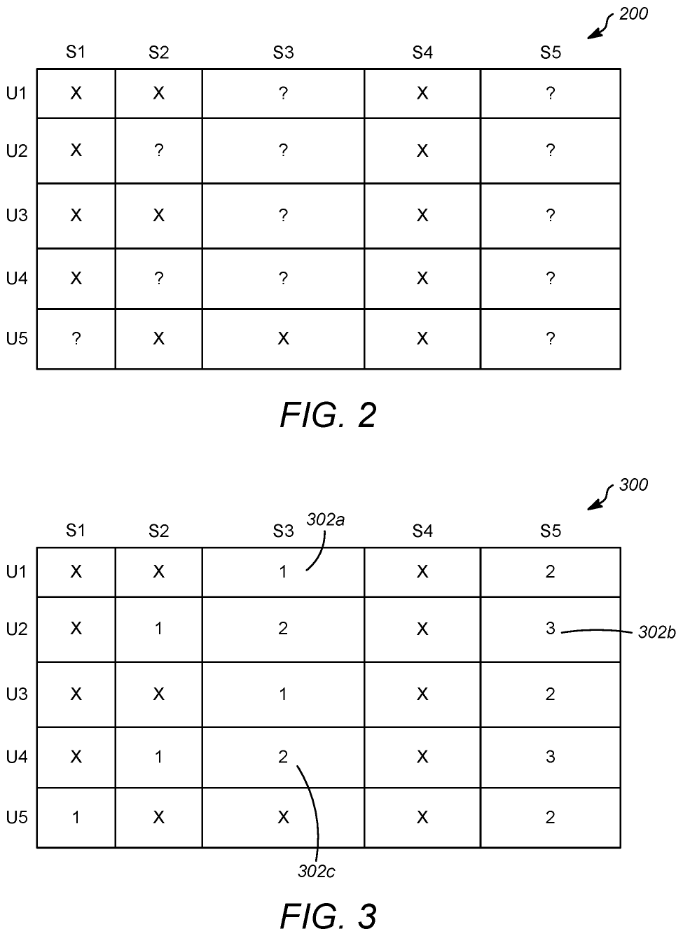

FIG. 2 depicts a user or client interest matrix 200 of users versus securities purchased which forms a basis for predicting customer interest for the recommendation database 108. The rows of matrix 200 represent individual users U1, U2, U3, U4, and U5. The columns of matrix 200 represent individual securities S1, S2, S3, S4, and S5. A security may be any type of stock, bond, mutual fund, commodity, option, or other investment vehicle that may be traded. In various embodiments, a security might represent a stock to be traded as an option. In the customer interest matrix 200 of FIG. 2, an X indicates prior interest by a user “a” in a particular security “b”. The question marks (“?”) in matrix 200 indicate no known interest. In various embodiments, an X may be a floating point number between zero and one or zero and 100 indicating the weight of interest by a particular user “a” in a security “b”. In various embodiments, it is desirable to create a model that not only preserves user preferences for previously purchased securities, as represented by the cells with an X in FIG. 2, but also to predict the relative rankings for stocks for which there has not been previously expressed interest by a particular user “a” in a security “b”. Accordingly, it is desirable to replace the question marks with predicted relative rankings.

Matrix 300 of FIG. 3 provides an example of the matrix 200 of FIG. 2 with the question marks replaced by relative rankings of securities for which users have not previously expressed interest. The relative rankings 302a, 302b, 302c (only a subset of cells of matrix 300 having rankings referred to using reference numbers) can be generated in accordance with factorizing the client interest matrix 200 of FIG. 2 into a pair of smaller matrices. The pair of matrices includes a first matrix having the users U1, . . . , U5 as the rows of a matrix and a second matrix having the securities S1, . . . , S5 as the columns. The columns of the first matrix and the rows of the second matrix are generated in accordance with latent factors, as will be described herein.

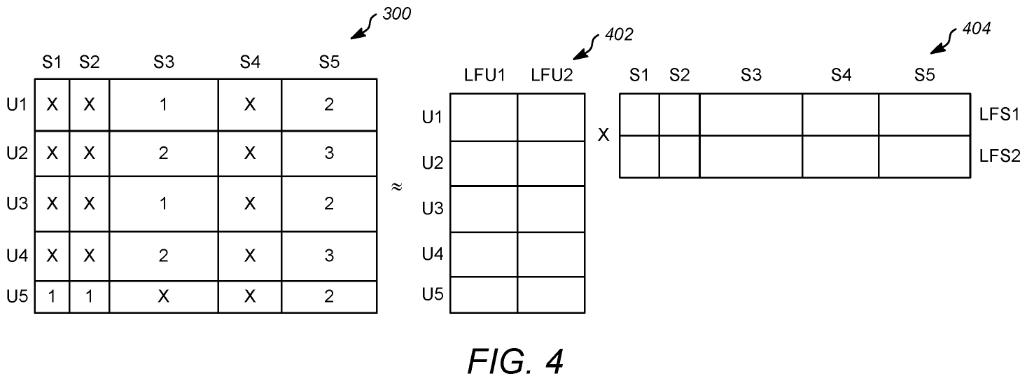

With reference to FIG. 4, matrix 300 is shown as factorized by a user matrix 402 having rows U1, . . . , U5 and a pair of columns LFU1, LFU2. Columns LFU1, LFU2 describing respective latent factors associated with users U1, . . . , U5. Similarly, a security matrix 404 includes columns corresponding to each security S1, . . . , S5 and a pair of rows LFS1, LFS2. Rows LFS1, LFS2 describe latent factors related to respective securities S1, . . . , S5, for each security.

By factoring the matrix 300 into user matrix 402 and security matrix 404 and by applying latent factors, the brokerage is able to significantly increase the scope of offerings reviewed and recommended. By way of non-limiting example, a brokerage can consider the entirety of its clients or users and the entirety of securities available to its clients. For example, a brokerage firm may have ten-million clients and may offer over fifteen-thousand securities to be traded. The permutations result in a recommendation matrix having over one-hundred-fifty billion client-security combinations, which would require significant data storage capacity to represent the full, un-factorized matrix 300. Accordingly, in order to consider all of the clients and the securities available to the clients, factorization as shown in FIG. 4 significantly reduces the computational overhead in considering all options available to the user of FIG. 1 in terms of both what other clients have purchased and the entirety of the securities available to the client.

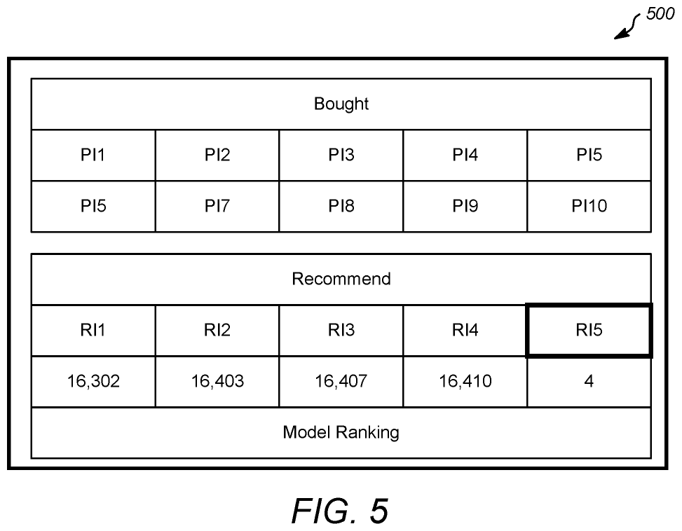

FIG. 5 depicts an example ranking formulated in accordance with purchased securities and generated in accordance with factorization as described with respect to FIGS. 2-4. In FIG. 5, a plurality of securities, PI1, . . . , PI10 represent securities within a particular user's portfolio. Securities PI1, PI10 can be all the securities ever within a particular user's portfolio or selected based upon a time range or a snapshot in time. Based upon the purchased securities P1, . . . , P10, a set of recommendations, recommended securities RI1, . . . , RI5 are generated with an associated ranking. Accordingly, example ranking table 500 of FIG. 5 indicates that of the recommended securities RI1, . . . , RI5, RI5 is the preferred, recommended security having a ranking of four. By way of comparison, RI4 is the least preferred recommended security having a ranking of 16,410. An example recommendation system can be found with reference to U.S. patent application Ser. No. 16/371,063, filed Mar. 31, 2019, and entitled Recommendation System for Providing Personalized and Mixed Content on a User Interface Based on Content and User Similarity, assigned to the assignee of the present application, the entire disclosure of which is incorporated by reference herein.

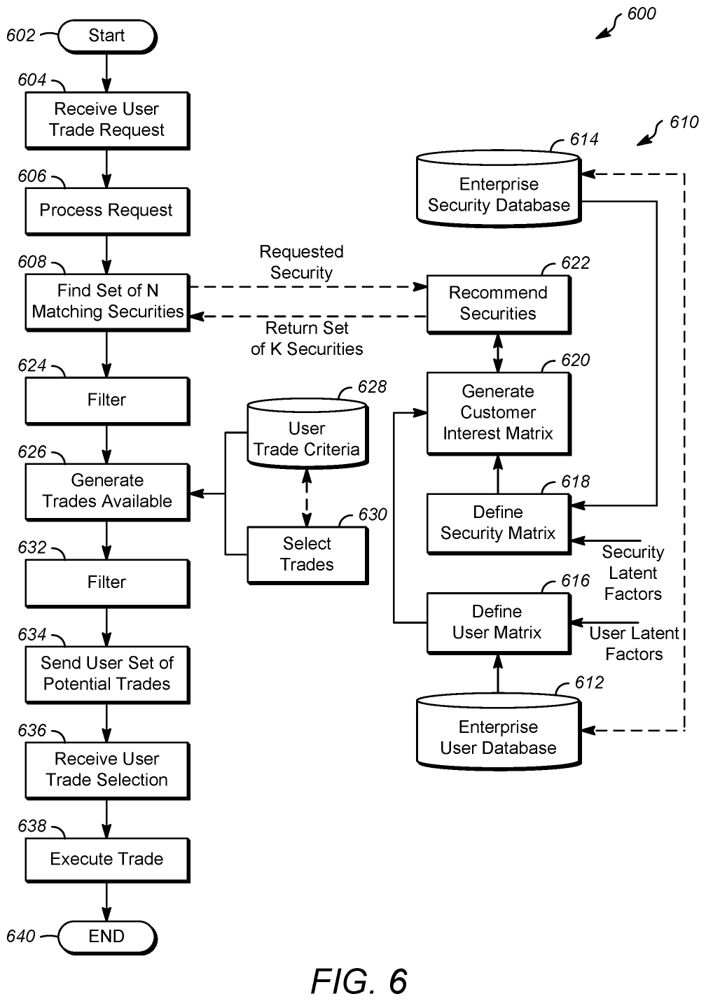

FIG. 6 depicts a flow chart 600 detailing one example of operation of the recommendation system of FIGS. 1-5. Control begins at block 602 and proceeds to block 604. Block 604 receives a user trade request, which may be a request for a purchase of a particular security to be traded. In the example of FIG. 6, the trade to be executed is a purchase. However, one skilled in the art will recognize that other trades, such as sales of securities, are equally applicable to the flow chart of FIG. 6. At block 604, the user may initiate a trade request via text or speech. In various embodiments, the trade request can be received via a user device, such as a smart phone or a laptop 102 of FIG. 1. In the case of receiving a user request via a smart phone, the request may be initiated via a voice recognition system or a minimalist input, such as text message “buy security z”, where security z is any other number of securities available for purchase.

Control proceeds to block 606 which receives the user trade request from block 604. At block 606, the input from block 604 is processed to determine at least one of a security requested for purchase and, by way of non-limiting example, a particular type of purchase, such as an option trade. The specified security and trade determined at block 606 is input to block 608. Block 608 determines a set of matching securities, such as a predetermined number N of securities matching the requested security by the user. Block 608 communicates with a recommendation database 610 to receive from the recommendation database 610 a set of K securities purchased by other enterprise clients. In various embodiments, the K securities may be the most frequently purchased K securities by clients throughout the enterprise.

Recommendation database 610 includes an enterprise user database 612 and an enterprise security database 614. Enterprise user database 612 and enterprise security database 614 may be combined into a single database or, in various embodiments, may be a separate database. User data from enterprise user database 612 is input to block 616 which defines user latent factors, such as matrix 402 of FIG. 4, resulting from the factorization of the enterprise database of users versus securities. Similarly, recommendation database 610 includes block 618 which defines security latent factors 618, such as matrix 404 of FIG. 4, resulting from the factorization of the enterprise database of securities. At block 620, the user matrix 616 and security matrix 618 are multiplied to generate a recommendation matrix, such as matrix 300 described above with respect to FIGS. 2-4.

Block 622 receives a requested security from block 608. Block 622 queries the customer interest matrix in accordance with the requested security and returns a set of K securities most frequently purchased by the enterprise clients. The K securities are returned to block 608 which determines the top N matching securities from the set of K securities received from block 622. In various embodiments, block 608 generates N matching securities. The N matching securities are filtered at block 624 which may reduce the number of securities in accordance with predetermined criteria. The output from block 624 is input to block 626 which generates a set of available trades for the user.

In various embodiments, the available trades may be option trades. As is well known, options can require the consideration of a number of factors beyond simply the underlying security. In order to generate a list of available option trades, block 626 communicates with a user trade criteria database 628 and a select trades block 630. User trade criteria database 628 includes various criteria for trade matching, including risk tolerance, success probability, and expiration date range. The criteria can be automatically generated in accordance with past customer behavior, including either the customer making the particular request, the entirety of the customers across the enterprise, or a relevant subset of customers across the enterprise. In various other embodiments, user trade criteria can be stored in database 628 after querying the user about specific trade criteria. Select trades 630 receives the trade criteria and generates a list of available trades based on available option trades at the present time in the market. User trade criteria database 628 and select trades 630 provide input to block 626 which generates, for each security received from filter block 624, a list of available option trades. The list of available option trades can be further filtered at block 632 to further reduce the number of option trades presented to the user.

Block 634 sends a set or list of potential trades for consideration by the user. The potential trades can be, by way of non-limiting example, option trades and can be presented as a list for voice selection, touch screen selection, typed text, or text message by the user. Block 636 receives the user trade selection or selections and executes the trades at block 638. The process ends at block 640.

Further, with respect to recommendation database 610 in various embodiments, recommendation database 610 focuses on the related interests of the clients of the enterprise. For example, if a particular client is interested in a particular security, the database can be used to leverage what other clients might be interested in that security. Interest in the security can be determined in accordance with several factors including educational content available to the enterprise clients, ticker searches, research, and web page tracking, (such as cursor travel, pages viewed, how long a page is viewed), and other searches.

While the data related to gauging interested clients can be useful, in enterprises that may have well over ten-million clients and those ten-million clients have traded over fifteen-thousand securities, processing of the data presents a formidable challenge. It is desirable to continuously update the customer interest matrix 300. Conventional approaches would simply eliminate a matrix of users or clients versus securities. However, as described above, such a matrix has many cells which are indeterminate. In order to ensure that every cell has a measurable interest level in the users versus securities matrix, the matrix is factored as described above with respect to FIG. 5. Using the factorization approach described above, it is possible that the recommendation matrix be updated continuously and is not constrained by available computer resources. The recommendation matrix 300 can be updated with a significantly reduced amount of computing time and resources than a matrix of all users and all clients without the factorization described above. In various embodiments, recommendation matrix can be updated in response to predetermined triggers, such as high trade volume, mass sales of securities that have been held for an extended period, or a shifting of the window through which the purchase and sale of securities is viewed.

In various embodiments, the system described with respect to FIGS. 1-6 can be applied to other than trading options. By way of non-limiting example, the system can be applied to stocks, options, bonds, and exchange-traded funds (ETFs). The approach of FIGS. 1-6 can also be applied to trades involving both purchase and/or sale of securities.

In various embodiments, client-specific data can be used to further focus the generation of matching securities at block 608. Such data of the specific user can include geographic location, financial status, liquidity, prior success rate on trades, trading activity, total gain versus total loss, and other factors. Similar or different data can be applied to securities at 608. Such filters can be applied, by way of non-limiting example, at blocks 624 and 632. Such filters can also be applied via user criteria database 628. Thus, the more active a particular user or client is, the more specific recommendations can be formulated with respect to the particular user or client. With respect to block 630, user criteria at block 630 can be generated from database 628 and can be based on the particular requesting user or client or from clients having profiles similar to the specific requesting user or client.

Further, in various embodiments, the system described herein can be used by enterprise call centers to help formulate recommendations for client or users contacting a call center. Further yet, additional criteria of the call center can be factored into client interactions. For example, a particular call center associate or a particular profile of a call center associate may prove more helpful to a particular client or user. Thus, the matrix factorization described herein can be used for pairing clients or users with call center associates rather than particular securities. In addition, the described ranking technique can be applied to other ranking techniques for ranking other items of interest to yield a ranked list of items.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, Rust, Julia, and Python®.

What is claimed is:

1. A system comprising:
an input module receiving a request from a user that is a client of an enterprise;
an input processing module receiving the request and determining a requested option and requested security in accordance with the request;
a selection module that receives the requested option and requested security and determines matching securities in accordance with the requested option;
a recommendation module communicating with the selection module, the recommendation module receiving the requested security and generating the matching securities in accordance with the requested security, the recommendation module comparing the requested security to a matrix of all users of the enterprise and all securities purchased by all users of the enterprise, the comparing including factorizing the matrix in accordance with predetermined latent factors, the recommendation module returning the matching securities to the selection module;
a trade module receiving the matching securities and receiving trade criteria for the user;
a trade selection module receiving the matching securities and the trade criteria, the trade selection module generating at least one option trade in accordance with the matching securities and the trade criteria, the trade selection module returning the at least one option trade to the trade module; and
a user return module receiving the at least one option trade from the trade module, the user return module generating a selection list to the user for available option trade based on the at least one option trade,
wherein the user selects at least one option trade from the selection list thereby requesting execution of the selected at least one of the at least one option trade.

2. The system of claim 1 wherein the input module comprises a voice activated device configured to receive at least one of text or speech from the user.

3. The system of claim 2 wherein at least one of the input module, the input processing module, the selection module, the recommendation module, the trade module, the trade selection module, and the user return module communicates with at least one other of the input module, the input processing module, the selection module, the recommendation module, the trade module, the trade selection module, and the user return module via a cloud interface.

4. The system of claim 3 further comprising a user criteria database communicating with the trade module, wherein the user criteria database stores trade criteria including at least one of risk tolerance, probability of success, and options expiration ranges.

5. The system of claim 4 wherein trade module communicates the trade criteria to the trade selection module and the trade selection module generates the at least one option trade in accordance with the matching securities and the at least one of risk tolerance, probability of success, and options expiration ranges.

6. The system of claim 1 wherein at least one of the input module, the input processing module, the selection module, the recommendation module, the trade module, the trade selection module, and the user return module communicate with us with at least one other of the input module, the input processing module, the selection module, the recommendation module, the trade module, the trade selection module, and the user return module via a cloud interface.

7. The system of claim 1 further comprising a user criteria database communicating with the trade module, wherein the user criteria database stores trade criteria including at least one of risk tolerance, probability of success, and options expiration ranges.

8. The system of claim 1 wherein trade module communicates the trade criteria to the trade selection module and the trade selection module generates the at least one option trade in accordance with the matching securities and at least one of risk tolerance, probability of success, and options expiration ranges.

9. A method comprising:
receiving a request from a user that is a client of an enterprise and determining a requested option and requested security in accordance with the request;
determining matching securities in accordance with the requested option;
generating the matching securities in accordance with the requested security, and comparing the requested security to a matrix of all users of the enterprise and all securities purchased by all users of the enterprise, the comparing including factorizing the matrix in accordance with a predetermined latent factors, and returning the matching securities;
generating a at least one option trade in accordance with the matching securities and predetermined trade criteria, and returning at least one option trade; and
generating a selection list to the user for available option trades based on the at least one option trade,
wherein the user selects at least one option trade from the selection list thereby requesting execution of the selected at least one option trade.

10. The method of claim 9 further comprising receiving at least one of text or speech from the user.

11. The method of claim 10 further comprising storing trade criteria including at least one of risk tolerance, probability of success, and options expiration ranges.

12. The method of claim 11 further comprising generating the at least one option trade in accordance with the matching securities and the at least one of risk tolerance, probability of success, and options expiration ranges.

13. The method of claim 9 further comprising storing trade criteria including at least one of risk tolerance, probability of success, and options expiration ranges.

14. The method of claim 9 generating the at least one option trade in accordance with the matching securities and at least one of risk tolerance, probability of success, and options expiration ranges.
